(19) United States
(12) Patent Application Publication
(10) Pub. No.: US 2013/0060484 A1
(43) Pub. Date: Mar. 7, 2013

(54) Method for Establishing Gas Molecule Database

(71) Applicants: Tu Lee, Flushing, NY (US); Cheng-Hsin Liu, Kaohsiung City (TW); Hung-Lin Lee, Zhongli City (TW)

(72) Inventors: Tu Lee, Flushing, NY (US); Cheng-Hsin Liu, Kaohsiung City (TW); Hung-Lin Lee, Zhongli City (TW)

(73) Assignee: NATIONAL CENTRAL UNIVERSITY, Jhongli City (TW)

(21) Appl. No.: 13/223,692

(22) Filed: Sep. 1, 2011

(51) Int. Cl. G06F 19/00

(52) U.S. Cl. 702/24

(57) ABSTRACT

A method of establishing a database of gas molecules is disclosed. In this method, a metal-organic framework absorbs gas molecules of a guest material. Thereafter, after a predetermined time, the thermogravimetric analyzer (TGA) is utilized to make sure that the gas molecules have been adsorbed by the metal-organic framework. Finally, the metal organic framework with the gas molecules adsorbed thereon is analyzed by fluorescence spectrophotometer, and the light-emitting wavelength and waveform are recorded to establish a database of gas molecules.

### BACKGROUND OF THE INVENTION

1. Field of the Invention

The present invention relates to a method for establishing gas molecule database, and more particularly to a method for establishing gas molecule database that utilizes a metal organic framework to adsorb a guest material having gas molecules and analyzes through a thermogravimetric analyzer and a fluorescent spectroscope.

2. Description of the Related Art

A metal organic framework is a nanometer porous material and has a specific structural feature. The porous material can form a stand structure by mutual linkage. An organic material is usually taken as a stand edge, and metal molecules are taken as linkage points. This porous type structure can maximum the surface area of the material that is similar to porous sponges. Generally, the surface area of 1 gram metal organic framework is close to a football field. Moreover, pore size in the metal organic framework is a nanometer scale. The surface area can be further expanded by reducing pore diameters or increasing the number of pores, thereby increasing storage spaces.

The metal organic framework is mainly applied to inhalation solution or medicine. Next, a thermogravimetry analyzer and a fluorescent spectroscope are utilized to analyze it. In an aspect of the inhalation solution, it is usually applied to molecule separation or molecule recognition. In addition, in aspect of the inhalation medicine, the metal organic framework can be taken as a carrier of the medicines for controlling the speed of releasing the medicines.

However, the metal organic framework can also be utilized as gas storage application. Taiwan Patent No. 1304279 disclosed a novel metal organic framework, wherein its gas capable of being adsorbed comprises at least one gas selected from a group consisting of hydrogen, nitrogen, inert gas, carbon monoxide, carbon dioxide and a compound of producing and/or supplying the gas. In addition, U.S. Pat. No. 7,744,842 is related to a method for absorbing gas and separating gas mixture using carborane-based metal organic framework material, and more particularly to a method for separating carbon dioxide from a gas mixture. The method allows the gas mixture to be in contact with a metal organic framework having a three-dimensional carborane structure. The metal organic framework selectively absorbs carbon dioxide. U.S. Patent No. 20080190289 is a method for separating gas odorous substance. A filter having porous metal organic framework is utilized, and the metal organic framework comprises at least one, at least bidentate, organic compound which is bound by coordination to at least one metal ion so as to absorb the odorous substance within gas. The metal organic framework utilized in paragraph [0041] of the specification can comprise benzenedicarboxylate (BDC). U.S. Pat. No. 7,862,647 relates to a method for separating carbon dioxide from gas mixture. The method allows a gas mixture to be in contact with a metal organic framework material having dicarboxylic acid ligand and bipyridine ligand. The metal organic framework material selectively absorbs carbon dioxide. U.S. Patent No. 20100132549 is a gas separation system that utilizes a framework having zeolite imidazolate or imidazolate-derived framework to absorb gas having the specific structure, such as carbon dioxide, thereby achieving the efficacy of separating gas.

However, the feature for the gas storage of the metal organic framework is not utilized to establish a gas molecule database in connection with gas molecules.

### SUMMARY OF THE INVENTION

In view of the shortcomings of the prior art, the present invention is developed a method for establishing a gas molecule database as a principle objective to establish data of each gas molecule, thereby conveniently performing qualitative analysis for unknown gas molecules.

To achieve the foregoing objective, the method for establishing a gas molecule database according to the invention comprises the following steps: providing a metal organic framework and a guest material having gas molecules, wherein the metal organic framework and the guest material are separated by a distance and are positioned at the same closed container, the metal organic framework is used for adsorbing the gas molecule. Actually, the material of the metal organic framework can select Zn₈(Ad)₄(BPDC)₆O.2(NH₂CH3)²⁺, 8DMF, 11H₂O or [In(OH)BDC]ₙ. In addition, in this step, the metal organic framework and the guest material having the gas molecule are kept at a predetermined temperature. The predetermined temperature, for example, is 40° C.

Next, after a predetermined time, a thermogravimetry analyzer is utilized to analyze the metal organic framework to confirm that the metal organic framework has adsorbed the gas molecule when the predetermined time can be preset for 8 hours. After confirming that the metal organic framework has adsorbed the gas molecule, a fluorescent spectroscope is then utilized to analyze the metal organic framework with the adsorbed gas molecule and record a light-emitting wavelength and a waveform of the metal organic framework with the adsorbed gas molecule, thereby establishing the gas molecule.

Specifically, in order to increase the accuracy, in the step of providing the metal organic framework, impurities of the metal organic framework must be removed in advance. In another word, the metal organic framework is a porous material. The step of removing the impurities further comprises removing the impurities within pores of the metal organic framework to enhance the analysis accuracy. In addition, the analysis accuracy may also be influenced when the metal organic framework adsorbs water. Accordingly, the metal organic framework and the guest material having the gas molecule may not contain water as well.

In addition, the manner of increasing accuracy can also use a plurality of metal organic frameworks to respectively perform the foregoing steps. The gas molecule database has related data with respect to many metal organic frameworks adsorbing various gas molecules. Next, a coordinate system is used to record the light-emitting wavelength of the metal organic frameworks, wherein a plurality of coordinate axes of the coordinate system corresponds to the light-emitting wavelength of the metal organic frameworks. The coordinate system can be a rectangular coordinate system or a multi-axes coordinate system.

The method for establishing the gas molecule database according to the invention has the following advantages:

The method for establishing the gas molecule database of the invention is to adsorb the gas molecule of the guest material through the metal organic framework and utilizes the thermogravimetry analyzer and the fluorescent spectroscope to analyze the gas molecule.

### BRIEF DESCRIPTION OF THE DRAWINGS

FIG. 1 is a flowchart of a method for establishing a gas molecule database of the invention;

FIG. 2 is a schematic diagram for a metal organic framework and a guest material that are placed in the same closed container;

FIG. 3 is an analysis diagram of thermogravity loss for [In(OH)BDC]ₙ that adsorbs gas molecules of coffee powder;

FIG. 4 is an analysis diagram of thermogravity loss for [In(OH)BDC]ₙ that adsorbs gas molecules of aniseed;

FIG. 5 is an analysis diagram of thermogravity loss for [In(OH)BDC]ₙ that adsorbs gas molecules of cinnamon powder;

FIG. 6 is a waveform of using the fluorescent spectroscope to analyze [In(OH)BDC]ₙ that does not adsorb any gas molecule and that adsorbs gas molecules of coffee powder, aniseed and cinnamon powder;

FIG. 7 is a waveform of using the fluorescent spectroscope to analyze Zn₈(Ad)₄(BPDC)₆O.2(NH₂CH₃)²⁺, 8DMF, 11H₂O that does not adsorb any gas molecule and that respectively adsorbs gas molecules of aniseed and cinnamon powder;

FIG. 8 is a waveform of using the fluorescent spectroscope to analyze [In(OH)BDC]ₙ that does not adsorb any gas molecule and that respectively adsorbs gas molecules of aniseed and cinnamon powder;

FIG. 9 is a schematic diagram of using a coordinate system to record the light emission wavelength of the metal organic framework;

FIG. 10 is a schematic diagram of a light emission wavelength of the metal organic framework drawn by three-axes coordinate system; and

FIG. 11 is a schematic diagram of a light emission wavelength of the metal organic framework drawn according to the four-axis coordinate system.

### DETAILED DESCRIPTION OF THE PREFERRED EMBODIMENTS

The foregoing and other technical characteristics of the present invention will become apparent with the detailed description of the preferred embodiments and the illustration of the related drawings.

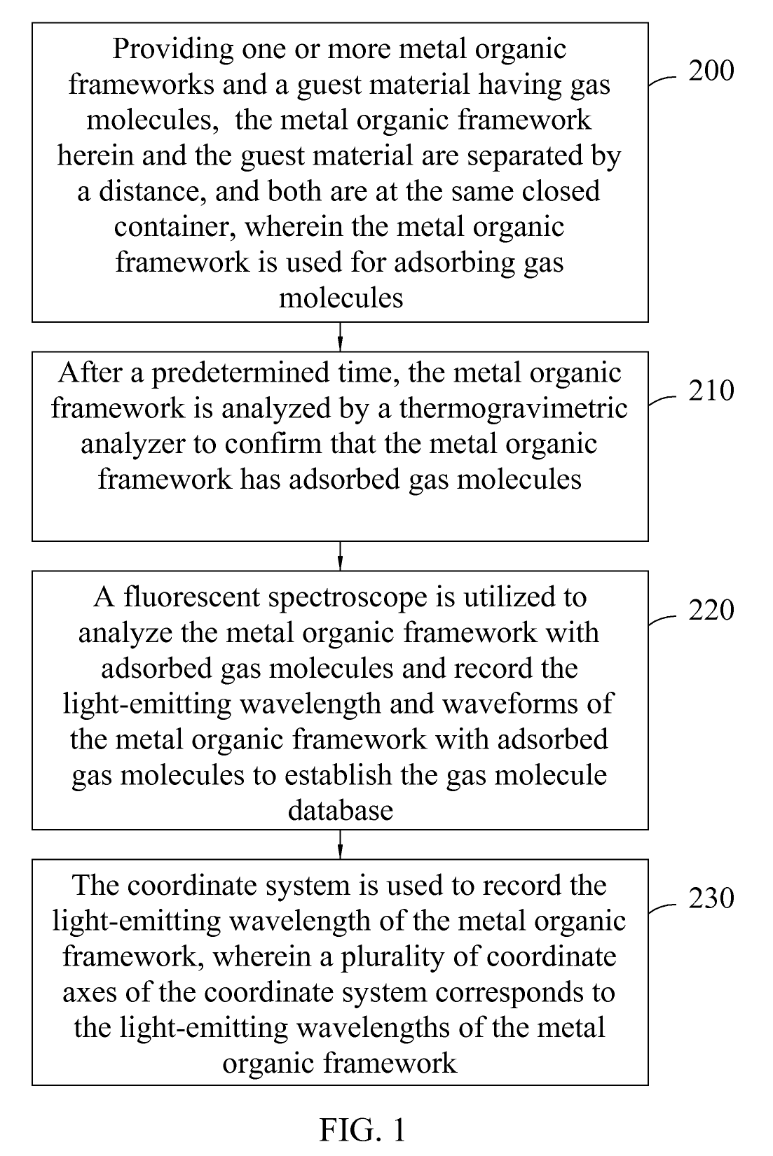

With reference to FIG. 1, FIG. 1 is a flowchart of a method for establishing gas molecule database of the invention. In the method for establishing gas molecule database, Step 200 is firstly performed to provide one or more metal organic frameworks and a guest material having gas molecules. The metal organic framework herein and the guest material are separated by a distance, and both are at the same closed container, wherein the metal organic framework is used for adsorbing gas molecules. Specifically, the invention is to adsorb gas molecules through the metal organic framework and then performs related analysis actions to establish a gas molecule database. It should be noted that in the method for establishing gas molecule database, the metal organic framework can not be in contact with the guest material and can be merely delivered by air so that gas molecules can be adsorbed on the metal organic framework. Actually, to avoid errors possibly generated by subsequent analysis, water percentages of the guest material and the metal organic framework are preferably zero. While providing the metal organic framework, a step of removing impurities of the metal organic framework must be firstly performed. It should be noted that since the metal organic framework has porous structures, the step of removing impurities of the metal organic framework further comprises removing the impurities within pores of the metal organic framework to reduce errors generated by analysis.

In the method for establishing gas molecule database of the invention, then step 210 then is performed. After a predetermined time, the metal organic framework is analyzed by a thermogravimetric analyzer to confirm that the metal organic framework has adsorbed gas molecules. The thermogravimetric analyzer is that a normal compound may be decomposed by heat in inert atmosphere, and may be burned in air or oxygen under a temperature rising condition, so as to express reduced weight. The reduced portion is a gas adsorbed by small molecules onto the sample or sample decomposed by itself. Thermogravimetric analysis is a technique of measuring a relationship between the mass and temperature of a substance under a controlled temperature procedure. Thermogravimetric analysis is to observe the weight variation of a sample by changing its temperature environment or maintaining at a fixed temperature so as to further determine the property and composition of the sample while placing the sample under a specific atmosphere. In another word, the thermogravimetric analyzer is utilized to confirm whether or not the metal organic framework has adsorbed gas molecules.

After confirming that the metal organic framework has adsorbed the gas molecules, next step is performed. In step 220, a fluorescent spectroscope is utilized to analyze the metal organic framework with adsorbed gas molecules and record the light-emitting wavelength and waveforms of the metal organic framework with adsorbed gas molecules to establish the gas molecule database. The fluorescent spectroscope utilizes luminescent fluorescence to analyze. The fluorescence is a process of releasing photons when an object receives external energy. Moreover, after the metal organic framework has adsorbed gas molecules, the gas molecules may influence the arrangement composition of pores of the metal organic framework. In another word, the fluorescent spectroscope is utilized to analyze the metal organic framework with different adsorbed gas molecules so as to obtain different light-emitting wavelength and waveforms. Afterward data of the light emission wavelengths and waveforms are then collected to establish the gas molecule database.

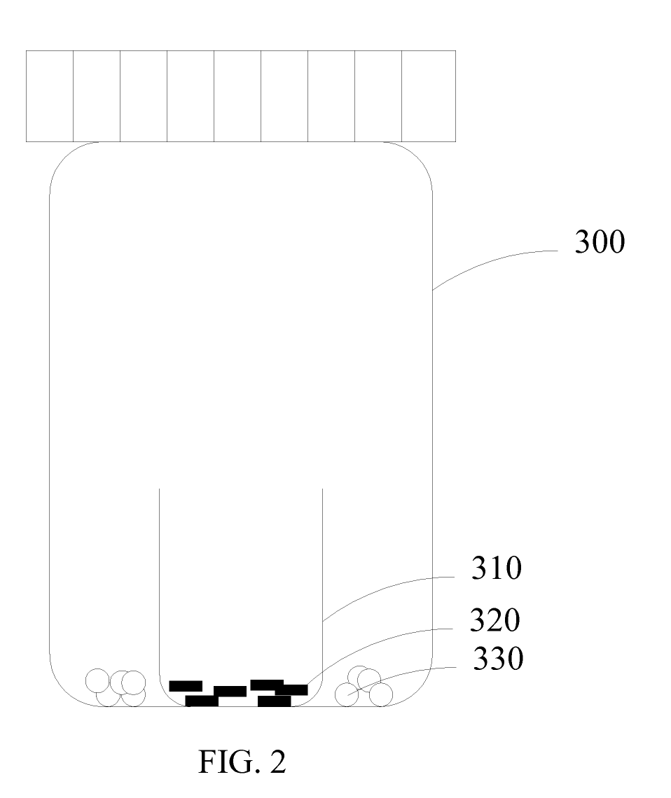

With reference to FIG. 2, FIG. 2 is a schematic diagram of placing the metal organic framework and the guest material at the same closed container. In FIG. 2, the metal organic framework 320 and the guest material 330 are placed in the same closed container 300, and the metal organic framework has a certain distance away from the guest material 330 through another container 310. To obtain stable analysis result, it can be analyzed by the thermogravimetric analyzer and the fluorescent spectroscope after setting at the predetermined temperature and time. For example, in a preferred embodiment, the predetermined temperature can be set at 40° C., and the predetermined time can be set for 8 hours.

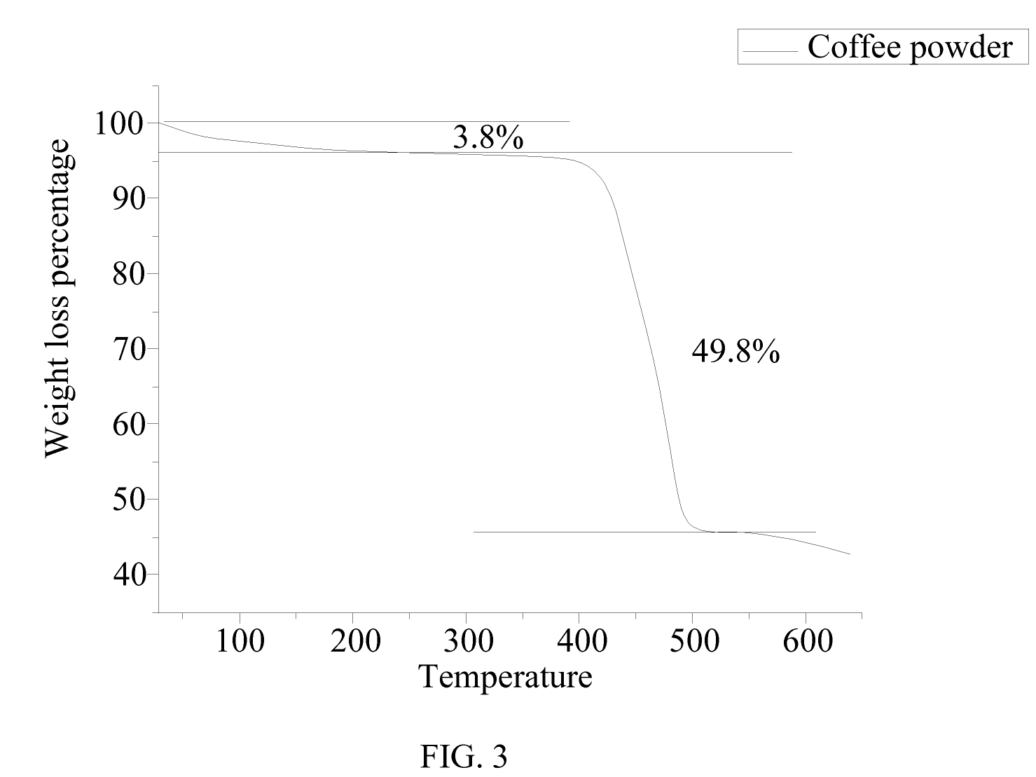

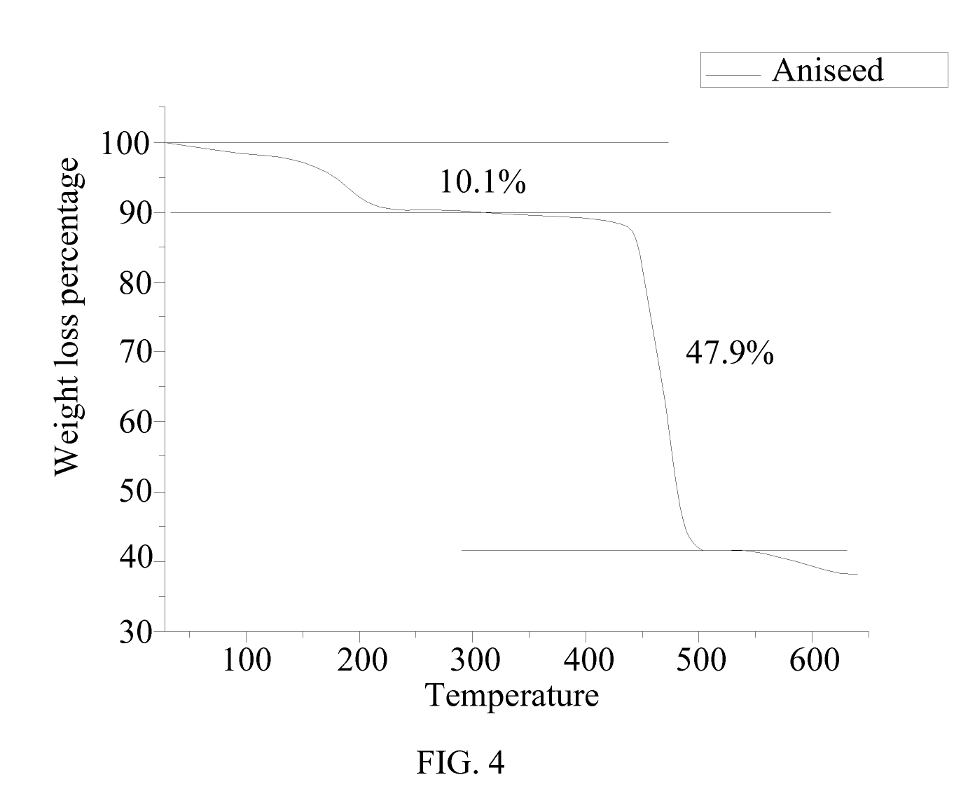

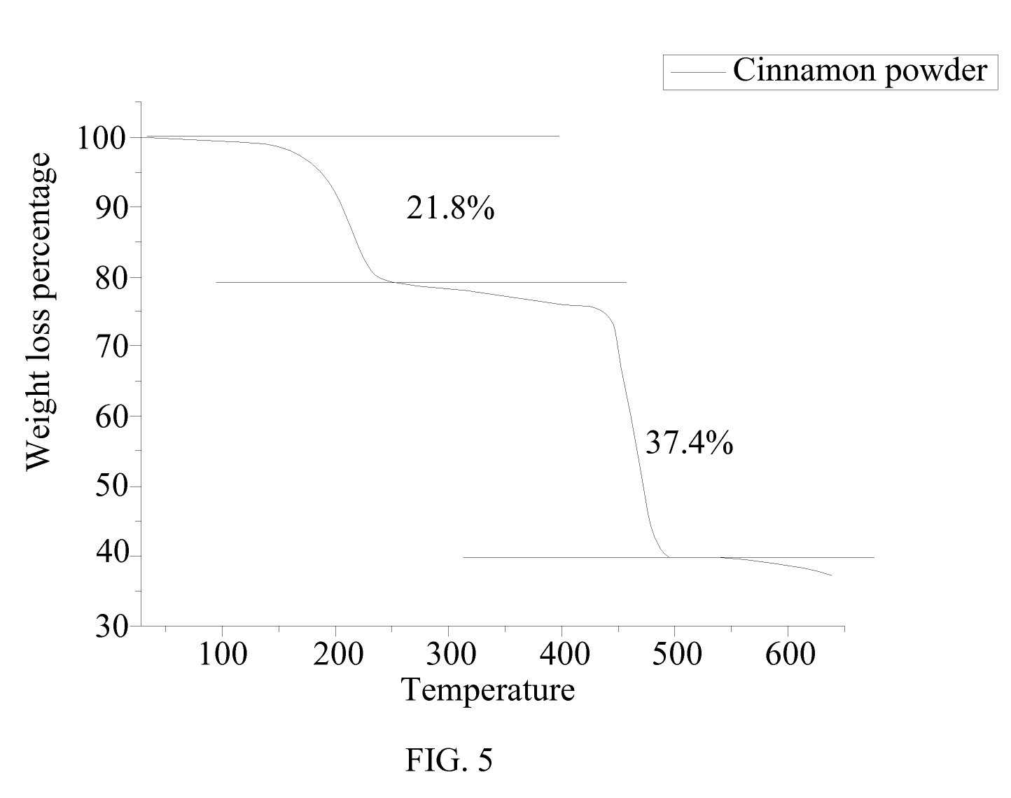

Herein three guest materials of the embodiments are provided to explain the method for establishing gas molecule database. Three guest materials are respectively coffee powder, aniseed and cinnamon powder. The material of the metal organic framework is [In(OH)BDC]ₙ. Next, with reference to FIG. 3 to FIG. 5, FIG. 3 is an analysis diagram of thermogravity loss for [In(OH)BDC]ₙ that adsorbs gas molecules of coffee powder, FIG. 4 is an analysis diagram of thermogravity loss for [In(OH)BDC]ₙ that adsorbs gas molecules of aniseed, and FIG. 5 is an analysis diagram of thermogravity loss for [In(OH)BDC]ₙ that adsorbs gas molecules of cinnamon powder. In FIG. 3 to FIG. 5, greater weight losses of two sections of larger slopes are found. It should be noted that the weight loss of larger slope near the temperature of 400 to 450° C. is a weight reduced by thermal decomposition of [In(OH)BDC]ₙ after comparing with [In(OH)BDC]ₙ that does not adsorb any gas molecule. In addition, after adsorbing gas molecules of coffee powder, [In(OH)BDC]ₙ has the weight loss of larger slope at the temperature of 25 to 50° C. Aniseed and cinnamon powder respectively have the weight losses of larger slopes at the temperature of 50 to 100° C. and the temperature of 150 to 200° C. In other words, the thermogravimetric analyzer can confirm that [In(OH)BDC]ₙ has exactly absorbed the foregoing three guest materials.

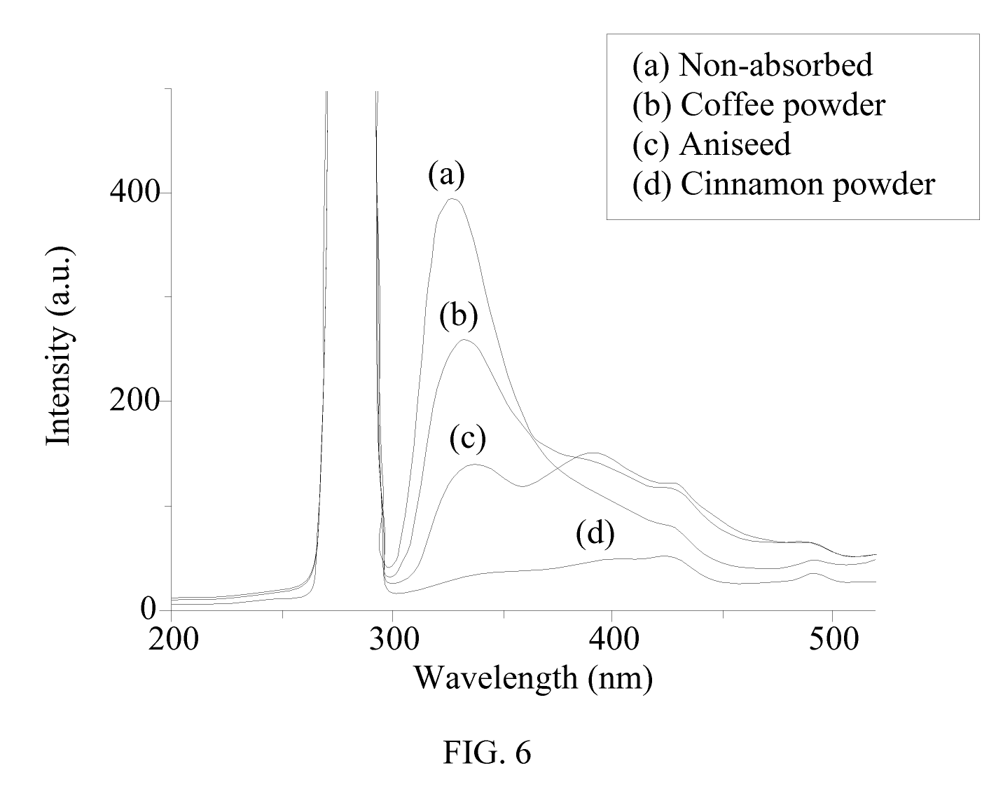

With reference to FIG. 6, FIG. 6 is a waveform of using the fluorescent spectroscope to analyze [In(OH)BDC]ₙ that does not adsorb any gas molecule and adsorbs gas molecules of coffee powder, aniseed and cinnamon powder. In FIG. 6, when [In(OH)BDC]ₙ does not adsorb any gas molecule and adsorbs gas molecules of coffee powder, aniseed and cinnamon powder, different light-emitting wavelengths and waveforms can be obtained by the analysis of the fluorescent spectroscope. Data of these light-emitting wavelengths and waveforms is established to form a database. If a user would like to test unknown gas molecule, it can be analyzed in qualitative by searching the database.

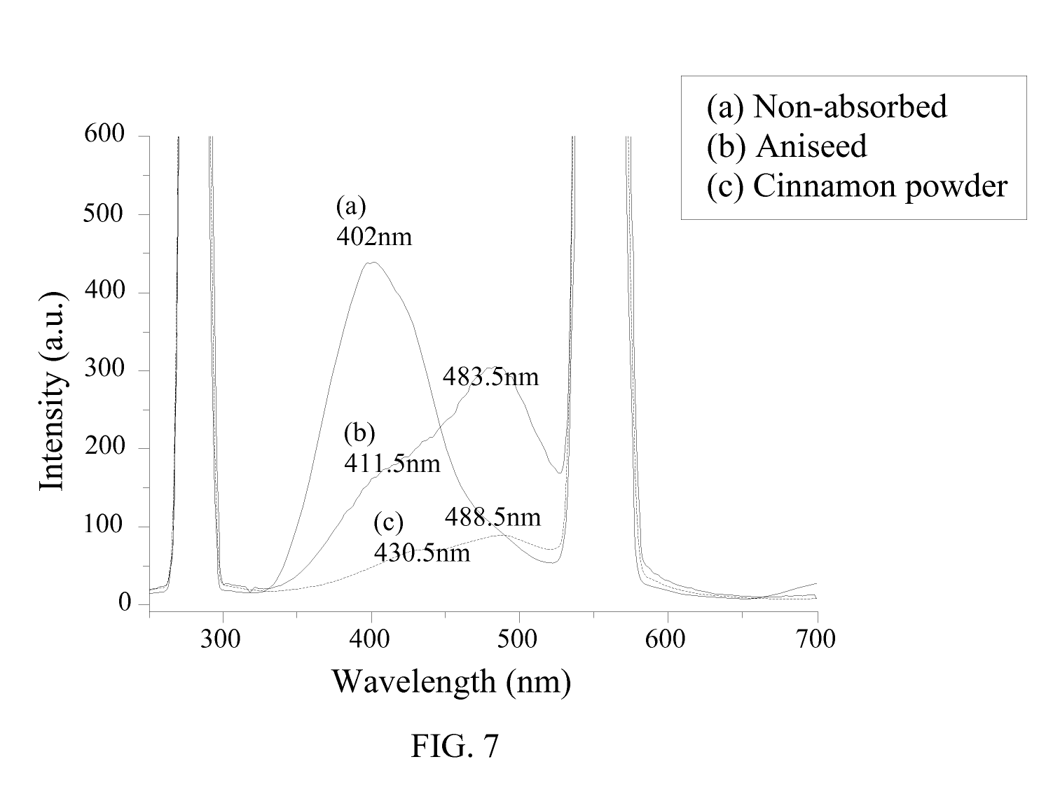

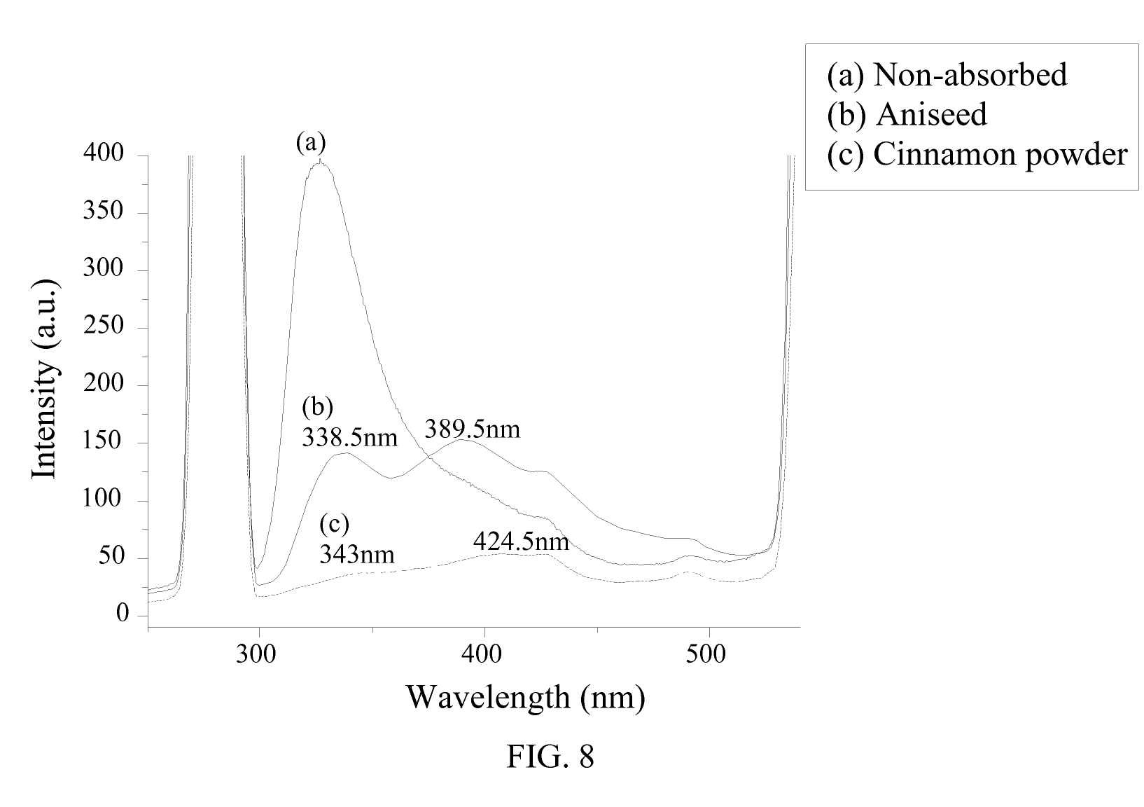

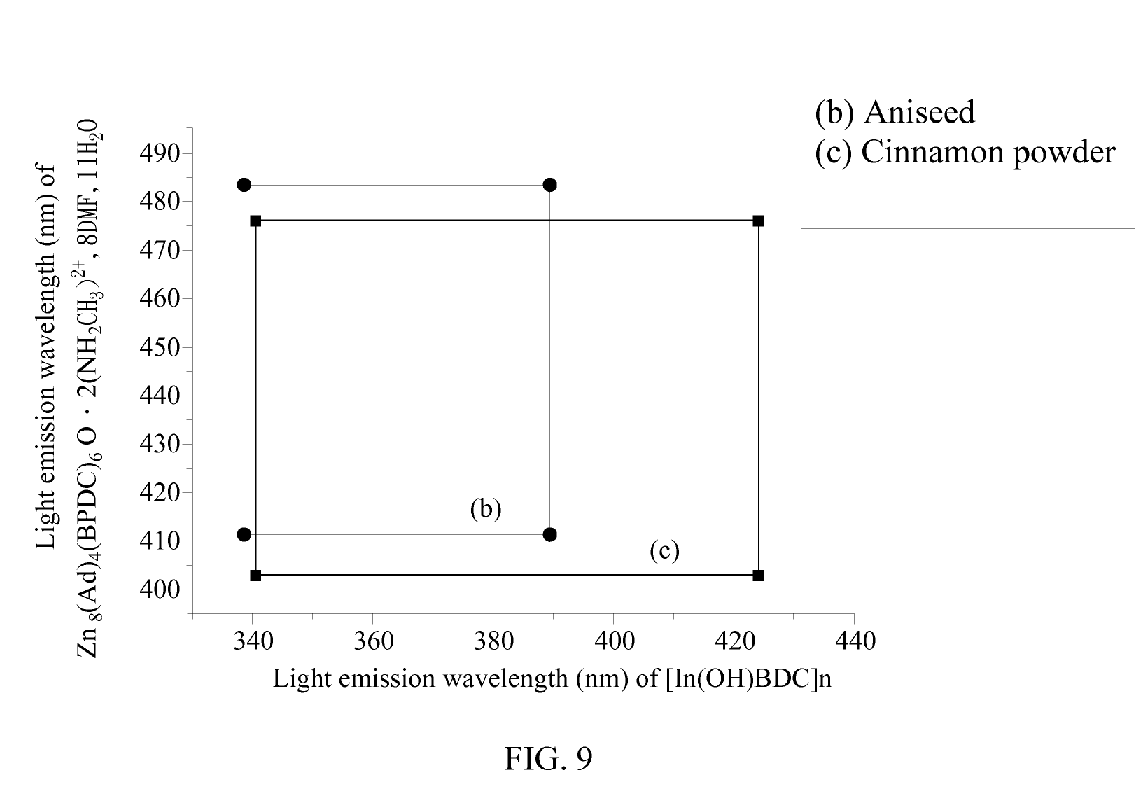

In addition, the invention can establish the database through a plurality of metal organic framework. With reference to FIG. 1, and FIG. 7 to FIG. 9, FIG. 7 is a waveform of using the fluorescent spectroscope to analyze Zn₈(Ad)₄(BPDC)₆O.2(NH₂CH₃)²⁺, 8DMF, 11H₂O that does not adsorb any gas molecules and that respectively adsorbs gas molecules of aniseed and cinnamon powder. FIG. 8 is a waveform of using the fluorescent spectroscope to analyze [In(OH)BDC]ₙ that does not adsorb any gas molecule and that respectively adsorbs gas molecules of aniseed and cinnamon powder. FIG. 9 is a schematic diagram of using a coordinate system to record the light-emitting wavelength of the metal organic framework. In FIG. 1, FIG. 7 to FIG. 9, it does not only perform Steps 200 to 220, but also performs Step 230. The coordinate system is used to record the light-emitting wavelength of the metal organic framework, wherein a plurality of coordinate axes of the coordinate system corresponds to the light-emitting wavelengths of the metal organic framework. It should be noted that it does not only utilize [In(OH)BDC]ₙ, but also uses another metal organic framework Zn₈(Ad)₄(BPDC)₆O.2(NH₂CH₃)²⁺, 8DMF, 11H₂O to adsorb gas molecules of aniseed and cinnamon powder. After comparing with the waveform of not adsorbing gas molecules, Zn₈(Ad)₄(BPDC)₆O.2(NH₂CH₃)²⁺, 8DMF, 11H₂O that adsorbs the gas molecules of aniseed has relatively high wave peaks at 411.5 nm and 483.5 nm, and [In(OH)BDC]ₙ that adsorbs gas molecules of aniseed has relatively high wave peaks at 338.5 nm and 389.5 nm. Next, light-emitting wavelengths of Zn₈(Ad)₄(BPDC)₆O.2(NH₂CH₃)²⁺, 8DMF, 11H₂O and [In(OH)BDC]ₙ are taken as axes, and the light-emitting wavelengths are respectively marked on the coordinate system to draw geometric patterns. FIG. 9 is drawn by a rectangular coordinate system. Therefore, if unknown gas molecules need to be tested, unknown gas molecules are adsorbed by Zn₈(Ad)₄(BPDC)₆O.2(NH₂CH₃)²⁺, 8DMF, 11H₂O and [In(OH)BDC]ₙ, and light-emitting wavelengths are measured. The measured light-emitting wavelengths is compared with geometric patterns drawn by the rectangular coordinate system in the gas molecule database to instantly analyze what is the unknown gas molecule. In addition, it should be noted that if there are more than three data of metal organic frameworks that adsorb gas molecules, schematic diagrams of light-emitting wavelengths of the rectangular coordinate system can be respectively drawn side by side to increase the compared accuracy.

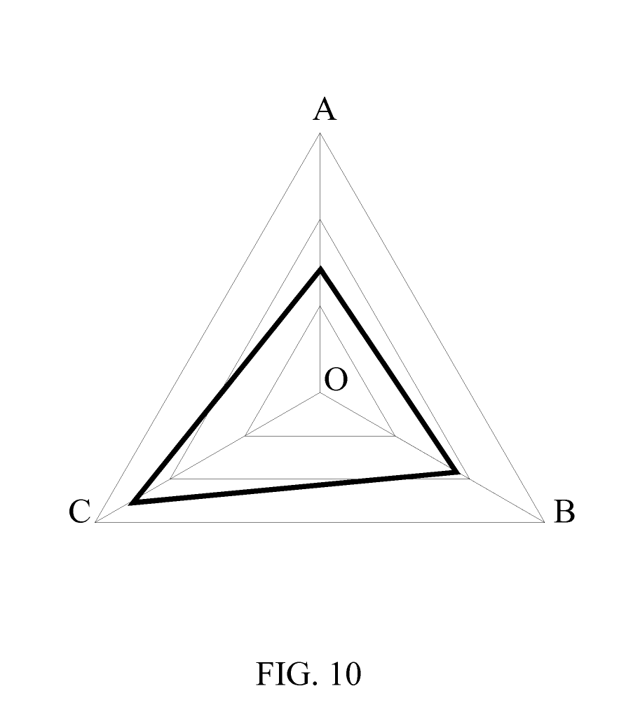

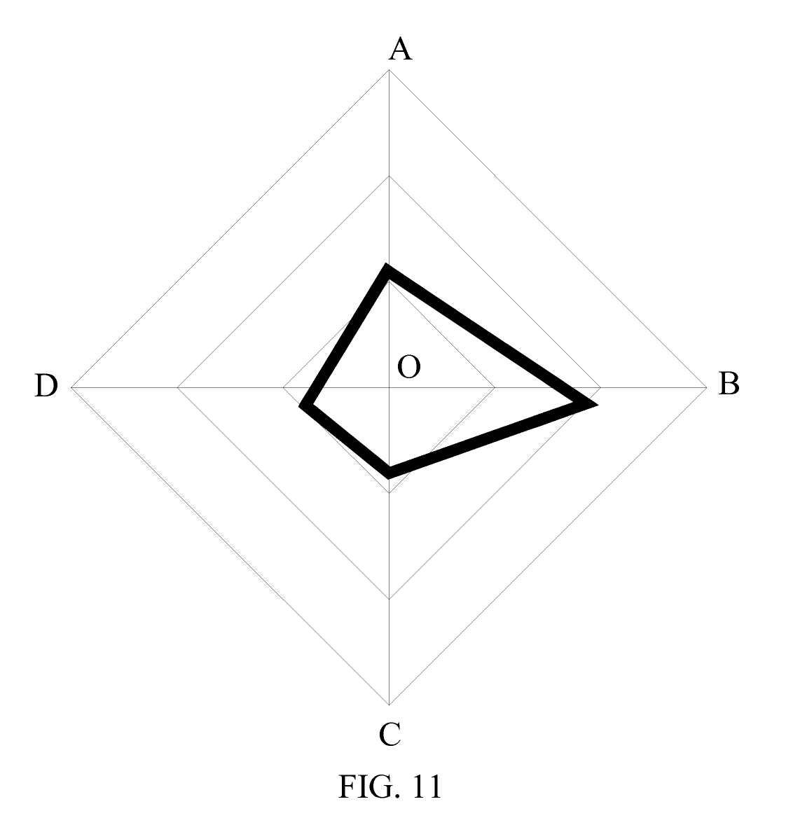

According to the method for establishing gas molecules using a plurality of metal organic frameworks that adsorb gas molecules, the coordinate system can also be shown by a multi-axis coordinate system. For example, with reference to FIG. 10, FIG. 10 is a schematic diagram of a light-emitting wavelength of the metal organic framework drawn by three-axes coordinate system. In FIG. 10, based on an OA line, an OB line and an OC line are respectively drawn from the O point while clockwise flipping 120 and 240 degrees. The OA line, the OB line and the OC line respectively correspond to the light-emitting wavelength coordinate axes of A, B and C three types of metal organic frameworks that adsorb gas molecules. Next, when A, B and C three types of metal organic frameworks adsorb gas molecules, relatively high wave peaks are respectively marked with points on the OA line, the OB line and the OC line, and each point is connected to each other to obtain a pattern belonging to the gas molecule. Preferably, units and scales of the OA line, the OB line and the OC line are the same to conveniently help a user to directly observe the pattern of the gas molecule. To simplify the pattern, in each metal organic framework, relatively high wave peak, for example, merely picks a light-emitting wavelength of the highest wave peak. Therefore, the drawn pattern is a triangle. However, the light-emitting wavelength of the highest wave peak herein shows that the light-emitting wavelength having wave peaks in the metal organic framework that adsorb gas molecules does not overlap the highest value in the metal organic framework that does not adsorb gas molecules by comparing the metal organic framework with the adsorbed gas molecules with the metal organic framework without the adsorbed gas molecules. In other words, taking FIG. 7 as an example, when a three-axes coordinate system is used to establish a gas molecule database, in Zn₈(Ad)₄(BPDC)₆O.2(NH₂CH₃)²⁺, 8DMF, 11H₂O adsorbing gas molecules of aniseed, the highest wave peak is 483.5 nm. Since wave peaks of 250 to 300 nm and 530 to 580 nm overlap the waveform that does not adsorb gas molecules, it may not match selected wavelength. In addition, a four-axes coordinate system can be derived upon the foregoing embodiments. With reference to FIG. 11, FIG. 11 is a schematic diagram of a light-emitting wavelength of the metal organic framework drawn according to the four-axis coordinate system. Since four axes must be drawn, an OB line, an OC line and an OD line are respectively drawn by flipping an OA line 90 degrees each time. However, it should be noted that the multiple axes coordinate system does not need to equally divide each axis to have the same degree.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A method for establishing a gas molecule database, comprising:
providing at least one metal organic framework and a guest material having a gas molecule, the metal organic framework and the guest material being separated by a distance and positioned in a same closed container, wherein the metal organic framework is used for adsorbing the gas molecule;
analyzing the metal organic framework through a thermogravimetry analyzer after a predetermined time to confirm that the metal organic framework has adsorbed the gas molecule; and
analyzing the metal organic framework with an adsorbed gas molecule through a fluorescent spectroscope after confirming that the metal organic framework has adsorbed the gas molecule, recording a light-emitting wavelength and a waveform of the metal organic framework with the adsorbed gas molecule, thereby establishing the gas molecule database.

2. The method for establishing a gas molecule database as recited in claim 1, wherein a material of the metal organic framework comprises Zn₈(Ad)₄(BPDC)₆O.2(NH₂CH3)²⁺, 8DMF, 11H₂O or [In(OH)BDC]ₙ.

3. The method for establishing a gas molecule database as recited in claim 1, wherein in the step of providing the metal organic framework and the guest material having the gas molecule, the metal organic framework and the guest material having the gas molecule are kept at a predetermined temperature.

4. The method for establishing a gas molecule database as recited in claim 3, wherein the predetermined temperature is 40° C.

5. The method for establishing a gas molecule database as recited in claim 1, wherein the predetermined time is 8 hours.

6. The method for establishing a gas molecule database as recited in claim 1, wherein the guest material comprises coffee powder, aniseed and cinnamon powder.

7. The method for establishing a gas molecule database as recited in claim 1, wherein water content percentages of the guest material and the metal organic framework are zero.

8. The method for establishing a gas molecule database as recited in claim 1, in the step of providing the metal organic framework, further comprising a step of removing impurities of the metal organic framework.

9. The method for establishing a gas molecule database as recited in claim 1, wherein in the step of providing the metal organic framework, numbers of the metal organic framework are plural.

10. The method for establishing a gas molecule database as recited in claim 9, in the step of establishing the gas molecule database, further comprising recording the light-emitting wavelength of the metal organic framework through a coordinate system, wherein a plurality of coordinate axes of the coordinate system correspond to the light-emitting wavelength of the metal organic framework.
